(19) United States
(12) Patent Application Publication
(10) Pub. No.: US 2002/0019854 A1
(43) Pub. Date: Feb. 14, 2002

(54) Method of accessing remote data

(76) Inventor: Miklos Sagi, Komaromi (HU)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/893,578

(22) Filed: Jun. 29, 2001

(30) Foreign Application Priority Data
Jun. 30, 2000 (GB) 0016251.1

(51) Int. Cl. G06F 15/16

(52) U.S. Cl. 709/217

(57) ABSTRACT

A method of accessing remote data from a portable device. The method includes monitoring a user interface of the portable device for the selection of an item of information from a plurality of items of information presented to the user of the portable device on a display, each item of information being associated with further information. In response to the selection of an item of information from the plurality of items of information, a first request is sent to a remote server for associated information. Whilst waiting for the receipt of the associated information, monitoring is carried out for a subsequent selection of a further item of information from the plurality of items of information. In response to a subsequent selection, a request is sent for the associated information of the further item of information to a remote server.

### BACKGROUND OF THE INVENTION

This invention relates to a method of accessing remote data and a portable wireless device capable of displaying information to a user. The use of the internet (and in particular the World Wide Web (WWW)) is well known. In the WWW a transfer protocol called Hyper Text Transfer Protocol (HTTP) is used to transfer information from a remote internet server to a device on which the information is displayed e.g. the monitor of a PC. Making the contents of the WWW available to portable devices that typically have a much smaller display than that of a PC has been the recent task of the Wireless Application Protocol (WAP) forum.

One WAP-enabled device already on the market prior to the filing date is the Nokia® 7110 phone. A user can use this phone to access information services. When waiting for a requested item of information, a user is presented with a screen that simply informs the user that the device is waiting for information. Since the data rates used in WAP at the current time are relatively low (of the order of 14.4 kbit/s) this may be displayed for a significant period of time, which may be annoying to a user.

### SUMMARY OF THE INVENTION

In accordance with the invention there is provided apparatus and a method of accessing remote data. In a first aspect of the invention there is provided a method of accessing remote data from a portable device. The method includes:

monitoring a user interface of the portable device for the selection of an item of information from a plurality of items of information presented to the user of the portable device on a display, each item of information being associated with further information stored on a remote server;

in response to the selection of an item of information from the plurality of items of information, sending a first request to a remote server for associated information;

waiting for the receipt of the associated information in response to the first request;

whilst waiting for the receipt of the associated information, monitoring for a subsequent selection of a further item of information from the plurality of items of information and, in response to a subsequent selection, sending a request for the associated information of the further item of information to a remote server; and

on receipt of the associated information, presenting to a user an indicator to indicate this receipt, the indicator includes the momentary display of the received associated information.

Thus a user is still able to browse the information originally displayed to the user and to request further information whilst waiting for the response to the first request. When the response is received, the momentary display of the received associated information (i.e. the display of the information lasts for only a moment) alerts a user to the receipt. In addition, an icon may be presented on the display together with the plurality of items of information. Preferably the information associated with the further request is presented to the user in response to an input by the user. Preferably when the associated information is received it is stored in a memory. A list of the selected items of information for which the associated information has been received may be formed and displayed on the display of the device. The device may then monitor for a selection of an item of information from the list and in response retrieve from memory the further information associated with the item selected from the list. Preferably the list is ordered in order of request or in reverse order of request.

On presentation of the plurality of items of information to the user a request may be sent to the remote server for the associated information for all of the items of information presented to the user. When a user selects an item of information from the plurality of items of information, a check may be made to ascertain whether the associated information of the selected item has already been received by the portable device. When the associated information of the selected item has not already been received by the portable device, a request is sent to the remote server for the information associated with the selected item. Preferably the request for the associated information for all of the items of information is cancelled when a request for the information associated with the selected item is sent.

The invention also relates to a portable device having a user interface and a display. The device includes:

apparatus to monitor the user interface of the portable device for the selection of an item of information from a plurality of items of information presented to the user of the portable device on the display, each item of information being associated with further information;

a processor that is arranged, in response to the selection of an item of information from the plurality of items of information, to send a first request to a remote server for associated information and to wait for the receipt of the associated information in response to the first request;

the processor being further arranged to monitor, whilst waiting for the receipt of the associated information, for a subsequent selection of a further item of information from the plurality of items of information and, in response to a subsequent selection, to send a request for the associated information of the further item of information to a remote server, and, on receipt of the associated information, present to a user an indicator to indicate this receipt, the indicator includes the momentary display of the received associated information. Preferably the device is a portable telecommunications device and/or conforms to the Wireless Application Protocol.

According to a third aspect of the invention, there is provided a browser for accessing data from a remote server. The browser is arranged to:

monitor a user interface for the selection of an item of information from a plurality of items of information presented, each item of information being associated with further information stored in a remote server;

in response to the selection of an item of information from the plurality of items of information, to send a first request to a remote server for associated information;

wait for the receipt of the associated information in response to the first request;

whilst waiting for the receipt of the associated information, to monitor for a subsequent selection of a further item of information from the plurality of items of information and, in response to a subsequent selection, to send a request for the associated information of the further item of information to a remote server, and, on receipt of the associated information, presenting to a user an indicator to indicate this receipt, the indicator includes the momentary display of the received associated information.

According to a fourth aspect of the invention there is provided a method of accessing remote data. The method includes:

monitoring a user interface for the selection of an item of information from a plurality of items of information presented to the user on a display, each item of information being associated with further information stored on a remote server;

in response to the selection of an item of information from the plurality of items of information, sending a first request to a remote serverfor the associated information;

on receipt of the associated information in response to said first request, displaying the associated information on the display; wherein on presentation of the plurality of items of information to the user a request is sent to a remote server or servers for the further information associated with all of the items of information presented.

### BRIEF DESCRIPTION OF THE DRAWINGS

The invention will now be described by way of example only with reference to the accompanying drawings in which:

FIG. 1 shows an example of a portable device in which the invention is incorporated;

FIG. 2 is a schematic drawing of the electronics of the device that concern the invention;

FIG. 3 shows a wireless communication system;

FIG. 4 shows an example of the user interface presented to a user on a display of a portable electronic device;

FIG. 5 is a flow chart illustrating a first embodiment of the invention;

FIG. 6 is a flow chart illustrating a second embodiment of the invention.

### DETAILED DESCRIPTION OF THE INVENTION

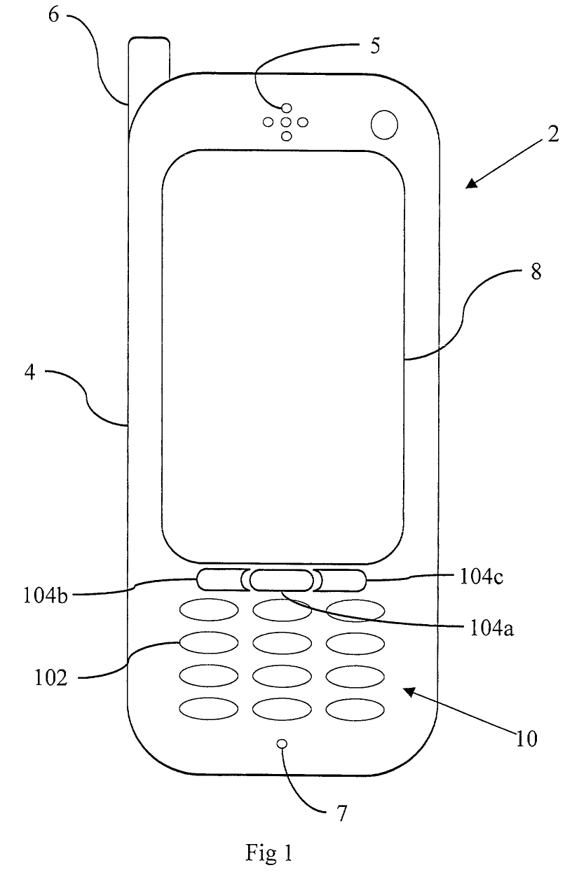

FIG. 1 shows an example of a portable device in which the invention can be incorporated. The device shown is a portable radio telecommunications device, a radio telephone 2. However the invention is applicable to other devices such as PDAs, palm computers, laptops etc. The radio telephone has a main housing 4 that houses the usual components of a radio telephone e.g. a speaker 5, an antenna 6, a microphone 7, a display 8, a user interface (UI) 10, and the electronics of the device (not shown). The electronics comprise (not exclusively) a transceiver, baseband circuitry and a processor for controlling the operation of the device. In the example shown the user interface is a keypad having alphanumeric keys 102 and control keys 104. However the user interface 10 may be of any form e.g. a joystick, a roller key, a voice interface, a touchscreen etc.

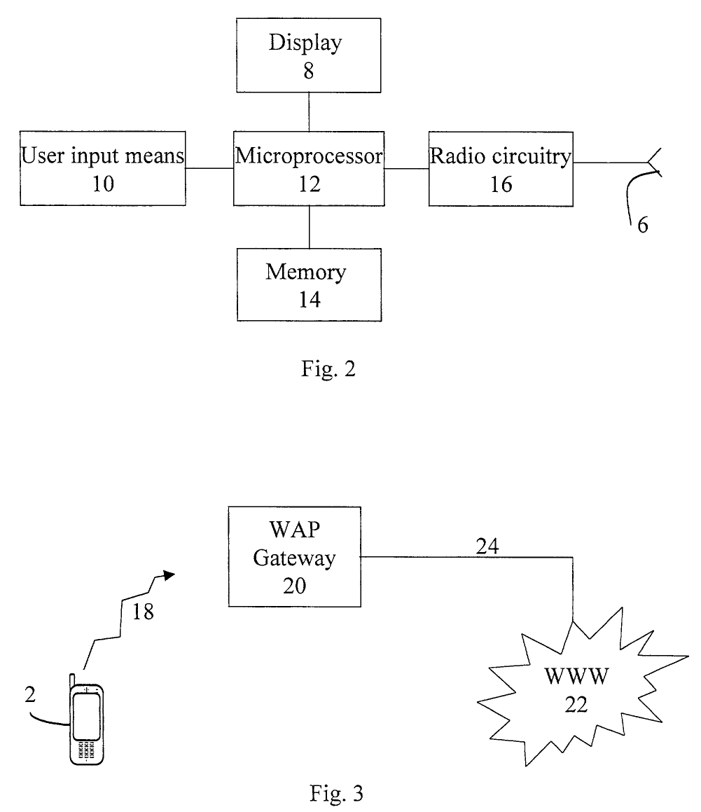

FIG. 2 is a schematic drawing of the electronics of the device that concern the invention. Other electronics may also be provided. A microprocessor 12 is connected to the display 8 and the user interface 10. It is also connected to RAM 14 which is also known as cache memory and to radio circuitry 16 which is responsible for the radio operation of the device. In use, the microprocessor 12 controls the input to and output from the memory 14, the information displayed on the display 8, the action of the device in response to inputs from the user interface 10, the radio circuitry 16 etc. The device 2 is capable of providing an information service to the user of the device. An example of such a service is akin to that of the World Wide Web (WWW). At the time of writing, this service is provided by means of the developing Wireless Application Protocol (WAP), which provides information coded in Wireless Markup Language (WML). The invention is not intended to be limited to this protocol or language and these will be used for exemplary purposes only. An example of such a device is the Applicant's WAP compliant phone, the 7110 model.

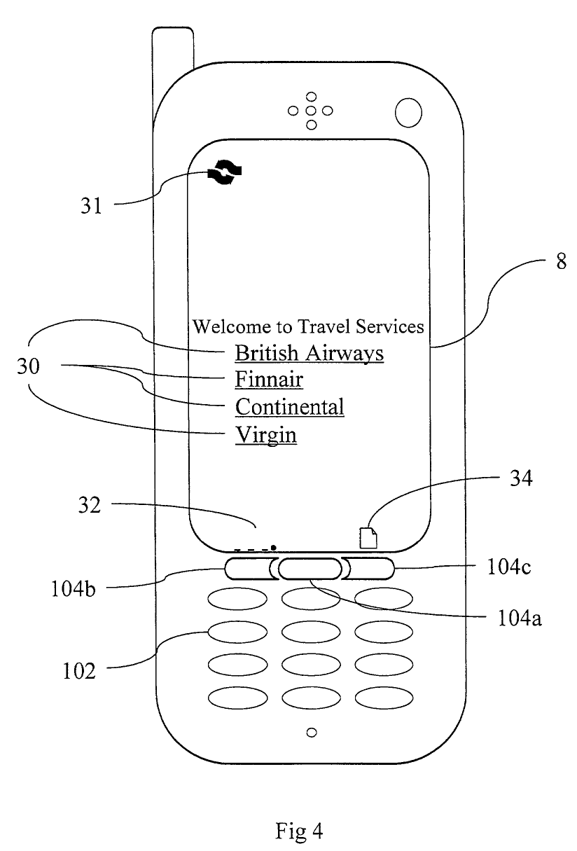

As shown with reference to FIG. 3, in use a WAP terminal 2 communicates by radio signals 18 with a WAP Gateway 20. The WAP Gateway is connected to the Internet (or World Wide Web (WWW)) 22 via a connection 24. The WAP Gateway 20 translates requests from WAP devices 2 from WAP into HTTP (Hyper-text Transfer Protocol), the protocol used for the WWW. The radio signals 18 conform to WAP and the signals sent via connection 24 conform to HTTP. The operation of the device when a user wishes to access information provided by WAP will now be described. The user selects the WAP service by selecting it from a main menu displayed on the display 8. This causes the device 2 to dial up the telephone number of the WAP Gateway 20. Once this connection is established an icon 31 is displayed (see FIG. 4) to indicate to a user that a connection is in existence. Information received from the WAP Gateway 20 is then presented on the display 8, as described below.

As shown in FIG. 4 information is displayed on the display 8 in the form of a plurality of items of information 30, each of which may be selected via the UI 10. In the embodiment shown in FIG. 4, items of information that are selectable are underlined. A user uses the user interface 10 to navigate between the selectable items 30. For instance, if the user interface is a keypad the navigation keys 104 are used to highlight each of the selectable items 30 in turn and to select an item.

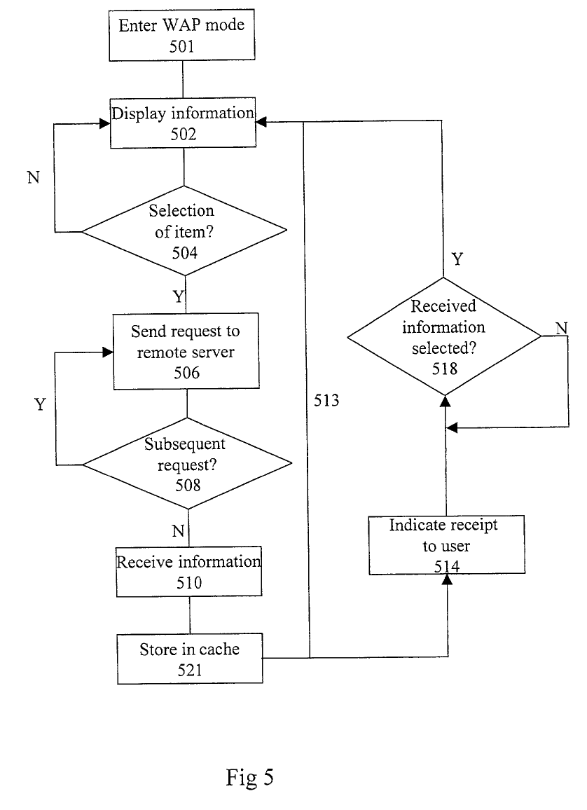

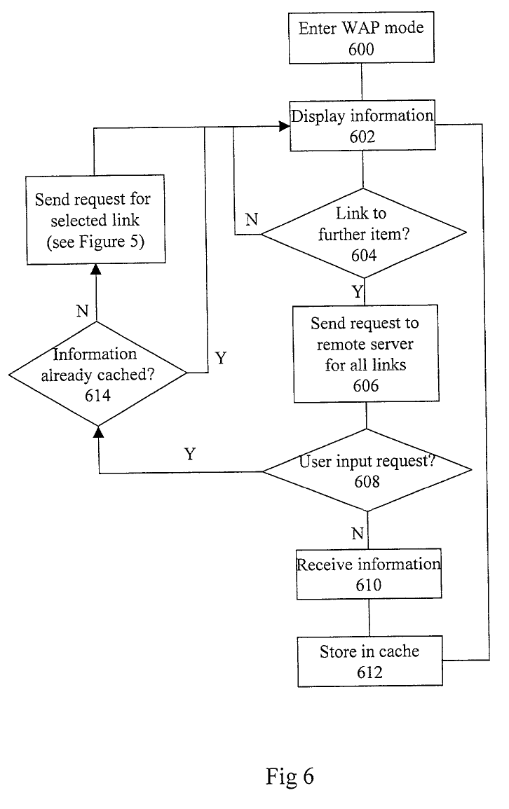

FIG. 5 is a flow chart illustrating the mode of operation of a browser according to a first embodiment of the invention. Once a connection to the WAP gateway 20 is made (501), information is displayed (502) on the display 8 (for instance as shown in FIG. 4). The user scrolls through the items of information for instance using a bi-directional control key 104a. Once the item that a user wishes to select (e.g. “British Airways”) is highlighted, it is selected (504) in response to a key press by the user on the keypad. This keypad press is detected by the microprocessor 12 which then sends (506) a WAP request to the WAP Gateway 20 for the information associated with the selected item of information (“British Airways”). The WAP Gateway 20 then translates the WAP request into an HTTP request and sends this to the Internet 22.

Meanwhile the microprocessor maintains the information as shown in FIG. 4 on the display 8 and continues to monitor (508) the user interface 10. An icon 32 is displayed at the bottom of the screen to indicate to a user that a request is being processed. A user can continue to browse the information displayed, whilst the request is being actioned. The microprocessor continues to monitor (508) the user interface 10 to detect the selection of another item of information from the plurality of items of information 30 shown on the screen. When a subsequent selection is made by the user (e.g. “Finnair”), the microprocessor 12 sends a subsequent WAP request (506) for the associated information to the WAP Gateway. If the user wishes to cancel the outstanding request(s), the control button 104b adjacent the icon 32 is operated. The device can therefore support more than one request at a time. In the above example, two requests are sent to the WAP Gateway, one for the first item of information (e.g. British Airways) and one for the second selected item of information (e.g. Finnair). The user is able to continue to browse the plurality of items of information 30 whilst these requests are being processed and to make further selections.

When the requested items of information are received (510) by the device, the microprocessor 20 stores (512) the items in the memory 14. The user is then informed of the receipt of the received information. The requested items of information may be displayed (513, 502) as soon as they are received, so overwriting the information currently displayed. However this may be irritating to the user who may be browsing or about to select a further item of information on the current screen. It is preferred therefore that a user is provided (514) with an indication that the information has been received. This may comprise the unobtrusive provision of an icon on the screen (e.g. icon 34) which a user may select by means of the UI 10. Alternatively, the received information may be momentarily displayed to the user (i.e. the received information is displayed to a user for an instant) and then the displayed information reverts to the information from which the item had been selected. This embodiment means that a user is informed of the arrival of the received information but the user's current browsing is not interrupted significantly. Preferably an icon 34 is also displayed and the user accesses the received information by operation of the key 104c associated with the icon. Alternatively an audio indicator may be provided to indicate the receipt of requested information.

Once the user is ready to view the received information, the user presses an appropriate control key e.g. key 104c next to the icon 34. Once this is detected (518) by the microprocessor 12, the received information stored in cache memory 14 is displayed on display 8. Each item of received information may be displayed to the user in turn upon successive operation of the key 104c. Alternatively the received items of information may be presented as a list of requested items, i.e. a list of the items of information for which further information is cached in memory 14. The list in the example discussed above would consist of “British Airways” and “Finnair”. The items are displayed to the user and the user selects the item to be displayed. The processor 14 then retrieves from memory 14 the further information associated with the selected item.

The list of items of information for which further information is cached in memory 14 may be ordered in the order of request, in the order of receipt, or preferably in the reverse order of request i.e. with the most recently requested associated information being listed first. If only one received item of information is stored in the cache this may be immediately displayed to the user on activation (518) of the key 104c. The associated information received and displayed may of course include a further plurality of items of information associated with further information on a remote server.

According to another aspect of the invention, a device automatically requests the download of the information associated with displayed items as soon as the items are displayed. This is illustrated in FIG. 6. When the WAP option is selected (600) the device dials up the WAP Gateway 20 which then sends “home page” information to the device which is then displayed (602) on the display 8, for instance as shown in FIG. 4. As this information is received, the microprocessor checks the information for further linked information (604). If such further links exist, the microprocessor automatically sends a request (606) to the WAP Gateway requesting the information associated with all the selectable items in the received information. As this information is received (610) by the device it is stored (612) in the cache 14.

When a user selects (608) a link from the displayed information, the microprocessor checks (614) to determine whether the selected information is already stored in the cache 14. If it is, the selected information is displayed 602. However, if the device has not yet received the selected information, the device may operate as already described with reference to steps 506 onwards of FIG. 5. The WAP request for the information associated with all the links is cancelled and replaced with a request for the information specifically requested. It is also envisaged that the content itself could be marked with an attribute “preloadable” to indicate whether the associated information is pre-loadable e.g. in WML this may be represented as follows: <ahref=“hftp://www.wgames.com/game1.wml” preloadable=“yes”>Game1</a>.

Thus when a device receives a WML page with the above information (or link), the device will read the attribute “preloadable” and automatically send a request for the associated information “game1.wml”, if the device is set up to operate in this way. The item “Game 1” is presented to a user. Additionally the WAP server/gateway 20 may be arranged to send automatically a request to the server for the associated information when such an attribute is received by the gateway. This associated information may then be sent on to the destination device automatically or when the gateway 20 receives a request for the further information from the destination device.

These various methods of handling the received information may be either pre-set (so that the device can only operate in a single way) or the user may be able to choose the method (513, 514, 600-614 etc.) of handling the received information. This latter option may be implemented by providing various options in a ‘Profiles’ menu on the device. The user can then select the option they prefer. This may be provided as a default “WML” page in the device. The user may be able to change the settings e.g. set the size of the cache memory, select whether or not to use the cache, set the time period for which the cached information is stored, set the type of information that may be cached (image, text, graphics, script etc.). A traditional web browser for a PC is capable of interpreting the received HTML and displaying it. However a WAP/WML browser can only display received information and cannot interpret it in the same way. The interpretation is carried out by the WAP gateway 20. The sending of multiple requests, as suggested by the invention, does not consume significantly more resources in the device.

The invention is applicable to any device or service that uses links to information stored on a remote site. Such services may be entertainment services such as games, etc.

What is claimed is:

1. A method of accessing remote data from a portable device, comprising:
monitoring a user interface of the portable device for the selection of an item of information from a plurality of items of information presented to the user of the portable device on a display, each said item of information being associated with further information stored on a remote server;
in response to the selection of an item of information from the plurality of items of information, sending a first request to a remote server for said associated information;
waiting for the receipt of said associated information in response to said first request;
whilst waiting for the receipt of said associated information, monitoring for a subsequent selection of a further item of information from said plurality of items of information and, in response to a subsequent selection, sending a request for the associated information of said further item of information to a remote server,
on receipt of said associated information, presenting to a user an indicator to indicate this receipt, the indicator comprising the momentary display of the received associated information.

2. A method according to claim 1, wherein an icon is presented on the display together with the plurality of items of information.

3. A method according to claim 1, wherein the information associated with the further request is subsequently presented to the user in response to an input by the user.

4. A method according to claim 1, further comprising:
receiving associated information and storing the associated information on a memory, forming a list of the selected items of information for which the associated information has been received, displaying the list on the display of the device, monitoring for a selection of an item of information from the list and retrieving from memory the further information associated with the item selected from the list.

5. A method according to claim 4, wherein the list is ordered in order of request.

6. A method according to claim 4, wherein the list is ordered in reverse order of request.

7. A method according to claim 1, wherein on presentation of the plurality of items of information to the user a request is sent to the remote server for the associated information for all of the items of information presented to the user.

8. A method according to claim 7, wherein, when a user selects an item of information from the plurality of items of information, a check is made to ascertain whether the associated information of the selected item has already been received by the portable device and, when the associated information of the selected item has not already been received by the portable device, sending a request to the remote server for the information associated with the selected item.

9. A method according to claim 8, further comprising:
cancelling the request for the associated information for all of the items of information when a request for the information associated with the selected item is sent.

10. A portable device having a user interface comprising input means and a display, the device comprising:
means to monitor the user interface of the portable device for the selection of an item of information from a plurality of items of information presented to the user of the portable device on the display, each said item of information being associated with further information;
a processor that is arranged, in response to the selection of an item of information from the plurality of items of information, to send a first request to a remote server for said associated information and to wait for the receipt of said associated information in response to said first request;
the processor being further arranged to monitor, whilst waiting for the receipt of said associated information, for a subsequent selection of a further item of information from said plurality of items of information and, in response to a subsequent selection, to send a request for the associated information of said further item of information to a remote server and, on receipt of said associated information, present to a user an indicator to indicate this receipt, the indicator comprising the momentary display of the received associated information.

11. A portable device according to claim 10, wherein the device is a portable telecommunications device.

12. A portable device according to claim 10, wherein the device is WAP device.

13. A browser for accessing data from a remote server, the browser being arranged to:
monitor a user interface for the selection of an item of information from a plurality of items of information presented, each said item of information being associated with further information stored in a remote server;
in response to the selection of an item of information from the plurality of items of information, to send a first request to a remote server for said associated information;
wait for the receipt of said associated information in response to said first request;
whilst waiting for the receipt of said associated information, to monitor for a subsequent selection of a further item of information from said plurality of items of information and, in response to a subsequent selection, to send a request for the associated information of said further item of information to a remote server, and, on receipt of said associated information, presenting to a user an indicator to indicate this receipt, the indicator comprising the momentary display of the received associated information.

14. A method of accessing remote data, comprising:
monitoring a user interface for the selection of an item of information from a plurality of items of information presented to the user on a display, each said item of information being associated with further information stored on a remote server;
in response to the selection of an item of information from the plurality of items of information, sending a first request to a remote server for said associated information;
on receipt of said associated information in response to said first request displaying the associated information on the display;
wherein on presentation of the plurality of items of information to the user a request is sent to a remote server or servers for the further information associated with all of the items of information presented.

15. A method of accessing remote data from a portable device, comprising:
monitoring a user interface of the portable device for the selection of an item of information from a plurality of items of information presented to the user of the portable device on a display, each said item of information being associated with further information stored on a remote server;
in response to the selection of an item of information from the plurality of items of information, sending a first request to a remote server for said associated information;
waiting for the receipt of said associated information in response to said first request;
whilst waiting for the receipt of said associated information, monitoring for a subsequent selection of a further item of information from said plurality of items of information and, in response to a subsequent selection, sending a request for the associated information of said further item of information to a remote server,
receiving associated information and storing the associated information in memory, forming a list of the selected items of information for which the associated information has been received, displaying the list on the display of the device, monitoring for a selection of an item of information from the list and retrieving from memory the further information associated with the item selected from the list.
